(19) United States
(12) Patent Application Publication
(10) Pub. No.: US 2016/0370451 A1
(43) Pub. Date: Dec. 22, 2016

(54) SUNLIGHT TRACKING SENSOR

(71) Applicant: AVRAHAM SEGEV, ATLIT (IL)

(72) Inventor: AVRAHAM SEGEV, ATLIT (IL)

(21) Appl. No.: 15/250,957

(22) Filed: Aug. 30, 2016

Related U.S. Application Data
(63) Continuation-in-part of application No. 14/085,977, filed on Nov. 21, 2013.

(51) Int. Cl. G01S 3/786

(52) U.S. Cl. CPC G01S 3/7861

(57) ABSTRACT

A sunlight tracking sensor including a right circular cone including a plurality of light sensors disposed thereon all around at a certain equal distance from an apex of the cone, and a motorized mechanism for tilting the cone perpendicularly from the sensor which provides the highest light measurement, thereby tilting the apex towards a sun, being a position of which all of the plurality of light sensors provide equal light measurements.

### CROSS-REFERENCE TO RELATED APPLICATIONS

This application is a Continuation-in-Part of U.S. patent application Ser. No. 14/085,977, filed Nov. 21, 2013, the disclosure of which is incorporated herein by reference.

### TECHNICAL FIELD

The invention relates to the field of sunlight tracking systems.

### BACKGROUND

Solar receptors (panels) are usually in the form of a plane on which are disposed a plurality of light sensors. The best mode to align such receptors is perpendicularly to the sunlight radiation, where the radiation is maximal. As the sun changes its location with regard to the earth, such sensor must be able to track the change.

In the prior art, some systems for solving this problem have been developed over the years, but they are not accurate enough, and are cumbersome, expensive and limited in their performance.

### SUMMARY

In one aspect, the invention is directed to a sunlight tracking sensor (10), including:
a right circular cone (60) including a plurality of light sensors (12a, 12b) disposed thereon all around at a certain equal distance (62) from an apex (64) of the cone (60); and
a motorized mechanism, for tilting the cone (60) perpendicularly from the sensor which provides the highest light measurement (78), thereby tilting the apex (64) towards a sun (38), being a position of which all of the plurality of light sensors (12a, 12b) provide equal light measurements (78).

### BRIEF DESCRIPTION OF THE DRAWINGS

Embodiments, features, and aspects of the invention are described herein in conjunction with the following drawings:

FIG. 1 is a front view of a sunlight tracking sensor, according to one embodiment of the invention.

FIG. 2 is a back view thereof.

FIG. 3 is a front view on a sunlight tracking sensor 10 of FIG. 1, from which lens 22 has been “removed”.

FIG. 4 is a sectional view schematically illustrating the sunlight tracking sensor of FIG. 1 in a situation wherein the sensor is diverted from the sunlight.

FIG. 5 is a sectional view schematically illustrating the sunlight tracking sensor of FIG. 1 in a situation wherein the sensor is in the optimal situation with regard to the sun beams.

FIG. 6 is a sectional view schematically illustrating the sunlight tracking sensor of FIG. 1 in a situation wherein the sensor is slightly diverted from the optimal situation with regard to the sunlight.

FIG. 7 schematically illustrates a sunlight tracking system 50, according to one embodiment of the invention.

FIG. 8 schematically illustrates a sunlight tracking system, according to another embodiment of the invention.

FIG. 9 is a front view on a sunlight tracking sensor, according to another embodiment of the invention.

FIG. 12 depicts a sunlight tracking sensor according to another embodiment.

FIG. 13 depicts the position to which the sunlight tracking sensor of FIG. 12 must reach in relation to the sun, and the light measurement at this position.

FIG. 14 depicts light measurements of the various light sensors at the position of FIG. 13.

FIG. 16 is a two-dimensional sketch, for analyzing the beams at the position of FIG. 12.

FIG. 17 depicts light measurements of the various light sensors at the position of FIG. 16.

FIG. 18 depicts the direction to which the cone must move upon measuring the illuminations of FIG. 17.

It should be understood that the drawings are not necessarily drawn to scale.

### DETAILED DESCRIPTION

The invention will be understood from the following detailed description of embodiments which are meant to be descriptive and not limiting. For the sake of brevity, some well-known features, methods, systems, procedures, components, circuits, and so on, are not described in detail.

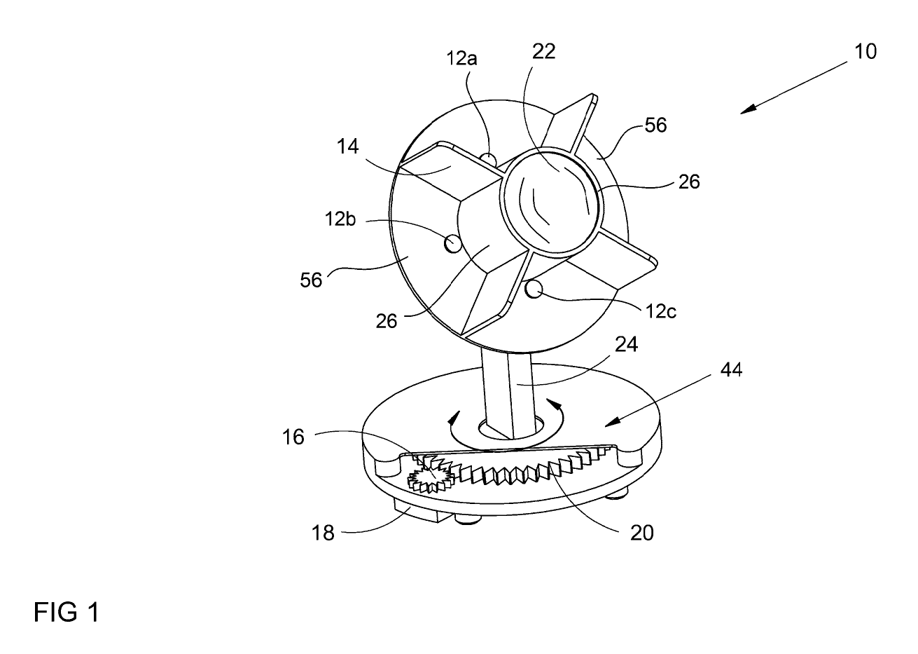

FIG. 1 is a front view of a sunlight tracking sensor, according to one embodiment of the invention.

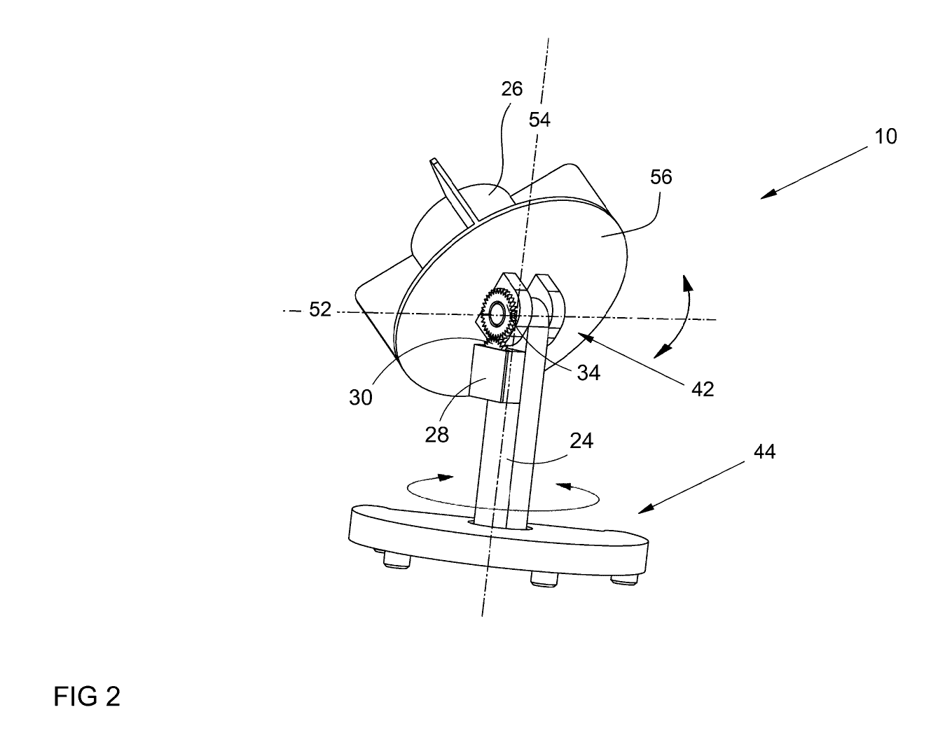

FIG. 2 is a back view thereof.

The sunlight tracking sensor, which is marked herein by reference numeral 10, comprises a non-transparent cylindrical wall 26, and four light sensors 12i (i=a, . . . ,d) disposed there around, preferably near the cylindrical wall 26, from the outer side of the cylindrical wall 26. Sensor 12a is disposed at the upper side of the cylindrical wall; sensor 12c is disposed at the bottom side of thereof; sensor 12b is disposed at the right side thereof and sensor 12d is disposed at the left side thereof. Optionally, planar walls 14 separate between sensors 12i.

The set of sensors 12i along with walls 26 and 14 are disposed on a base 56 which in this case is in a form of a plate. Thus, sensors 12i, and walls 14 and the cylindrical wall 26 move along with base 56.

Sunlight tracking sensor 10 also comprises a motorized mechanism for changing the orientation of base 56 (along with sensors 12i, walls 14, and cylindrical wall 26). The motorized mechanism comprises a first mechanism 42 for rotating base 56 around a horizontal axis 52, and a second mechanism for rotating base 56 around a vertical axis 54.

More particularly, the motorized mechanism comprises a first motor 28 which rotates base 56 around the horizontal axis 52, and a second motor 18 which rotates base 56 around the vertical axis 54.

More particularly, as per the rotation around the vertical axis 54, motor 18 rotates cogwheel 16 (seen in FIG. 1), which rotates pole 24 through which the vertical axis 54 passes. As per the rotation around the horizontal axis 52, motor 28 rotates cogwheel 30 (seen in FIG. 2), which rotates cogwheel 34 through which the horizontal axis 52 passes.

The object of walls 26 and 14 is to generate shaded areas in the location of sensors 12i in a situation wherein the orientation of sunlight tracking sensor 10 is not optimal, i.e., is not parallel to the sunlight beams. Under such conditions, a motorized mechanism can be directed to change the orientation of sensor 10 as follows:

If the light intensity of the upper sensor 12a is higher than the light intensity of the lower sensor 12c, then base 56 is rotated (along the horizontal axis 52) towards sensor 12a, and vice versa.

If the light intensity of the right sensor 12d is higher than the light intensity of the left sensor 12b, then base 56 is rotated (along the vertical axis 54) towards sensor 12d, and vice versa.

Thus, the motorized mechanism has to rotate base 56 towards the sensor with the higher light intensity of two opposite sensors. In this particular case, as one motor rotates the plate around a horizontal axis 52, and the other rotates the plate around a vertical axis 54, it is preferred to place sensors 12i one above the other (12a, 12c), and one on the right of the other (12b, 12d).

Generalizing this concept, assuming the motorized mechanism rotates base 56 around a vertical axis and a horizontal axis, then the base has to be rotated towards the higher/lower and left/right side from which its sensors sense higher light intensity.

Sensors 12i provide a rough indication about the correct orientation of sunlight tracking sensor 10. In order to provide a more accurate indication, a lens 22 (seen in FIG. 1) and a central sensor 36 are employed.

Actually, in the area are installed a certain number of light sensors; however, the light intensity can be calculated by interpolation means for each point (x,y) in the area, even if no sensor is present in this point.

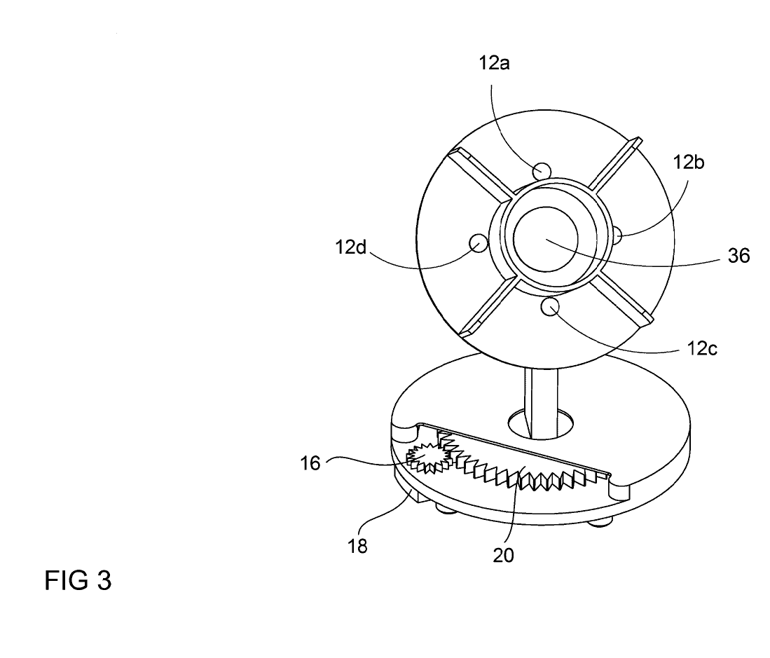

FIG. 3 is a front view on a sunlight tracking sensor 10 of FIG. 1, from which lens 22 has been “removed”.

If lens 22 is convex, and the central sensor 36 is disposed in its focus, the sunlight is concentrated on the central sensor. In this way, the orientation of sunlight tracking sensor 10 can be refined to the desired orientation. Actually, lens 22 is merely an example, and more sophisticated optical systems can be used in order to obtain high accuracy.

Thus, two stages of aligning sunlight tracking sensor 10 in the desired orientation are provided: a first stage in which the orientation of sensor 10 towards the sun can be adjusted roughly, and a second stage in which the orientation of sensor 10 towards the sun can be adjusted in a higher accuracy.

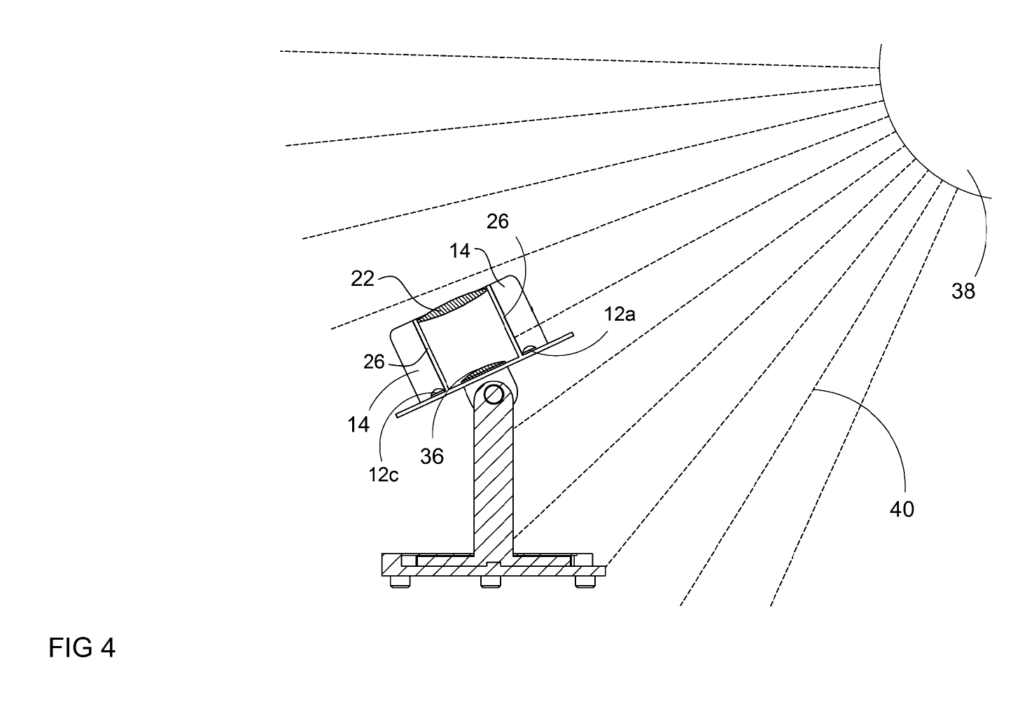

FIG. 4 is a sectional view schematically illustrating the sunlight tracking sensor of FIG. 1 in a situation wherein the sensor is diverted from the sunlight.

In this situation, sensor 12a receives a substantial amount of sunlight in comparison to sensor 3c. As such, the required rotation around the horizontal axis is clockwise (according to the figure's orientation). It should be noted that in this situation, central sensor 36 is useless, since no sunbeams meet lens 22.

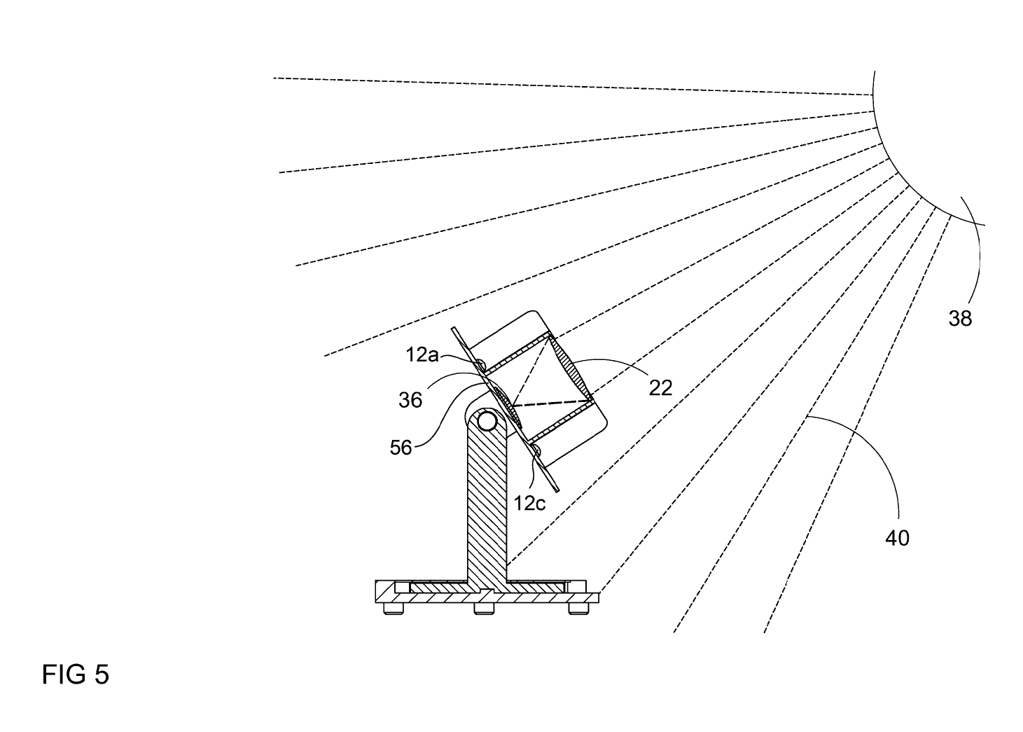

FIG. 5 is a sectional view schematically illustrating the sunlight tracking sensor of FIG. 1 in a situation wherein the sensor is in the optimal situation with regard to the sunbeams.

In this situation, the sunbeams are concentrated to the center of central sensor 36.

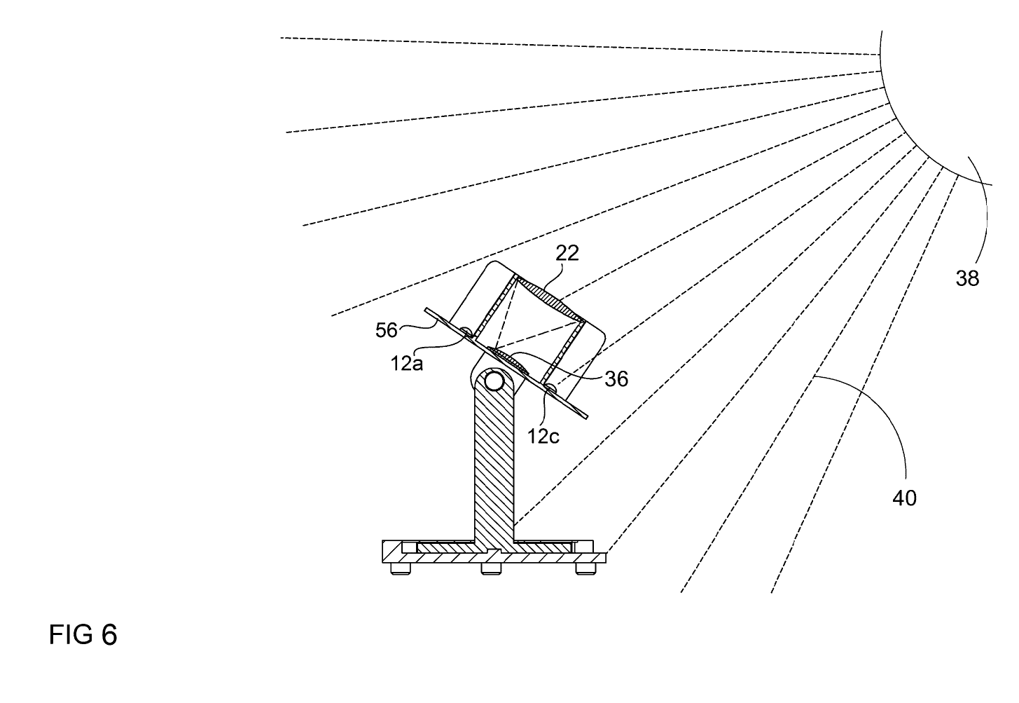

FIG. 6 is a sectional view schematically illustrating the sunlight tracking sensor of FIG. 1 in a situation wherein the sensor is slightly diverted from the optimal situation with regard to the sunlight.

In this situation, sensor 12a is shaded, and therefore the light intensity it senses is less than the light intensity sensed by the opposite sensor 12c. Furthermore, the concentration of the sunbeams on central sensor 36 is diverted from the center of the central sensor. Thus, under this situation, the motorized mechanism can be directed to rotate according to readings of both sensor 12i, and of central sensor 36.

It should be noted that in FIGS. 4 to 6, the sunlight beams have not been illustrated as parallel beams, for pictorial reasons.

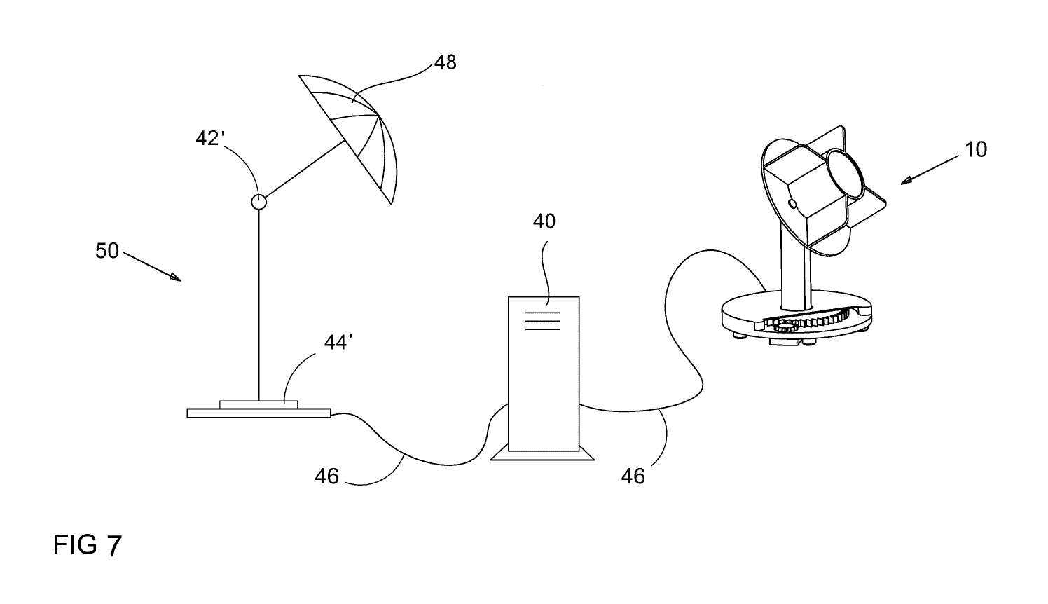

FIG. 7 schematically illustrates a sunlight tracking system 50, according to one embodiment of the invention.

Reference numeral 50 denotes a sunlight tracking system that comprises an object 48, such as an umbrella canopy and a solar panel, to be turned towards the sun. The system is operated by a motorized mechanism (mechanisms 42′, 44′) correspondingly to the first motorized mechanism (mechanisms 42, 44) of the sunlight tracking sensor 10.

Sunlight tracking system 50 also employs a sunlight tracking sensor 10, connected by wired or wireless communication 46 to a controller 40, which controls the operation of turning object 48, which in this case is an umbrella canopy, towards the sun.

The motorized mechanism of system 50 employs a first mechanism 42′ for rotating the umbrella canopy around a horizontal axis, and a second mechanism 44′ for rotating the umbrella canopy around a vertical axis. The controller 40 sends to the motorized mechanism instructions to rotate its rotation mechanisms 42′ and 44′ correspondingly to the rotation of rotation mechanisms 42 and 44 of the motorized mechanism of the sunlight tracking sensor 10.

Once the sunlight tracking system 50 is calibrated, i.e., umbrella canopy 48 is directed to the same direction as sensor 10, every movement of sensor 10 is repeated by umbrella canopy 48, thereby tracking the sunlight.

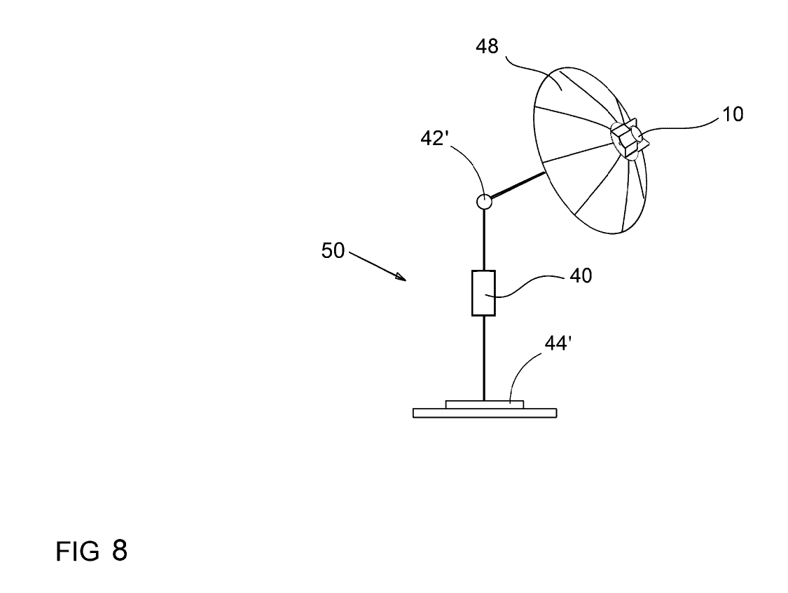

FIG. 8 schematically illustrates a sunlight tracking system, according to another embodiment of the invention.

According to this embodiment of the invention, sunlight tracking sensor 10 is installed on umbrella canopy 48 of the sunlight tracking system 50, and both sensor 10 and tracking system 50 use the same motorized mechanism. As a result, the motorized mechanisms 42′, 44′ turn both sensor 10 and umbrella canopy 48 to the same direction. Thus, as the orientation of sensor 10 towards the sun changes, the orientation of canopy 48 towards the sun also changes.

The umbrella is merely an example, and the invention can be implemented on a wide range of applications, including solar panels.

The difference between the embodiment of FIG. 7 and the embodiment of FIG. 8 is that, while in the embodiment of FIG. 8 each controlled device 48 uses a dedicated sensor 10, in the embodiment of FIG. 7 a single sunlight tracking sensor 10 controls a plurality of devices 48. As such, the embodiment of FIG. 7 is suited to, for example, a solar panel farm. On the other hand, calibrating the system of FIG. 8 is easier, and both, sensor 10 and the controlled device use the same motorized mechanism.

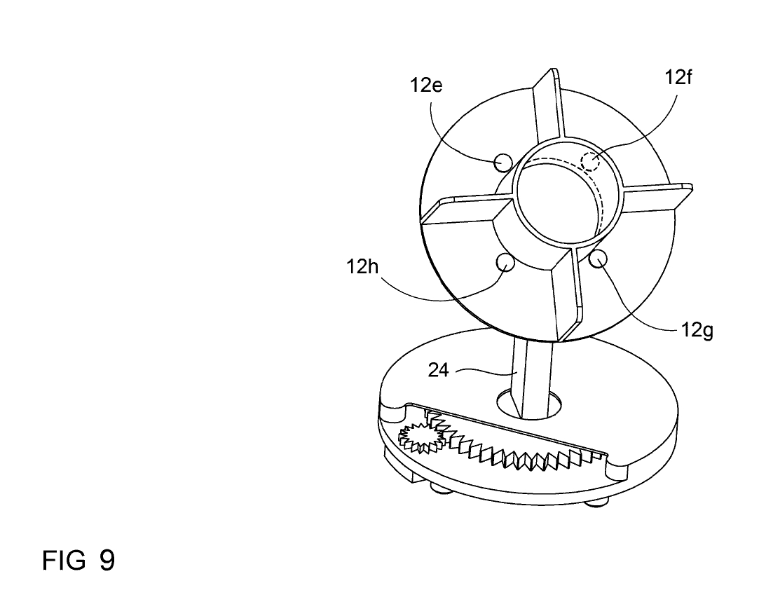

FIG. 9 is a front view on a sunlight tracking sensor, according to another embodiment of the invention.

If the sensors are not disposed in this order, as illustrated in FIG. 9, the average light intensity of the upper sensors (12e, 12f) is considered as the sensing of the high sensor, and the average light intensity of the lower sensors (12g, 12h) is considered as the sensing of the low sensor; the average light intensity of the sensors on the left (12e, 12h) is considered as the sensing of the left sensor, and the average light intensity of the sensors on the right (12f, 12g) is considered as the sensing of the right sensor.

FIG. 10 is a magnification of a portion of FIG. 8.

Sunlight sensor 10 is installed on the center top of an umbrella canopy 48, being sloped all around, from the top center/vertex such that the cylindrical profile 26 and the other walls are disposed perpendicular to the tangent of the center top.

FIG. 11 is a one dimensional view of FIG. 10.

Sunlight sensor 10 moves together with umbrella canopy 48. Thus, cylindrical profile 26 and the other walls are always disposed parallel to the sunbeams 40. This provides a mechanical control for shading under the vertex, as shown by the X.

Sunlight tracking sensor 10 may be mounted on the vertex of umbrella canopy 48, for moving umbrella canopy 48. The moving of sunlight tracking sensor 10 maintains sunbeam 40 parallel to peripheral profile 26 for not shading area sensor 36. The moving of umbrella 48 maintains sunbeam 40 perpendicular to the tangent of umbrella 48, for shading under the vertex. Thus, area sensor 36 accompanied with peripheral profile 26 and the other walls, maintain the accurate control on the movement of umbrella 48.

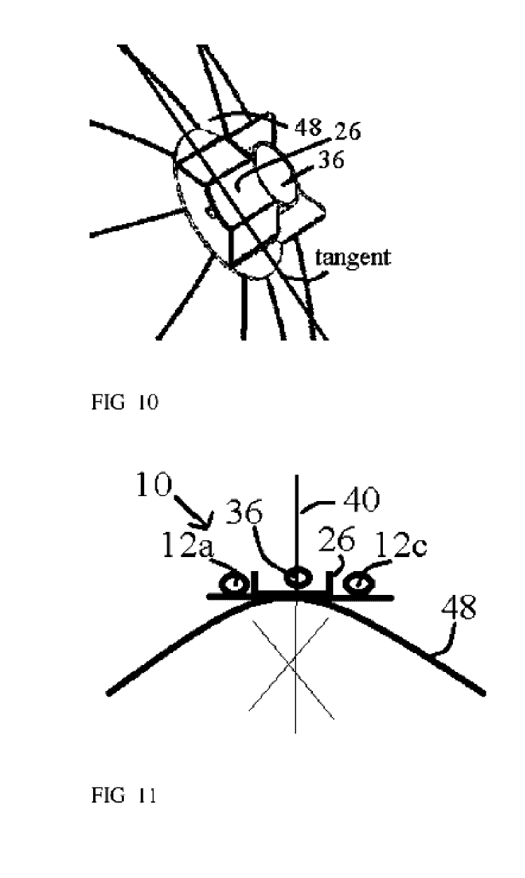

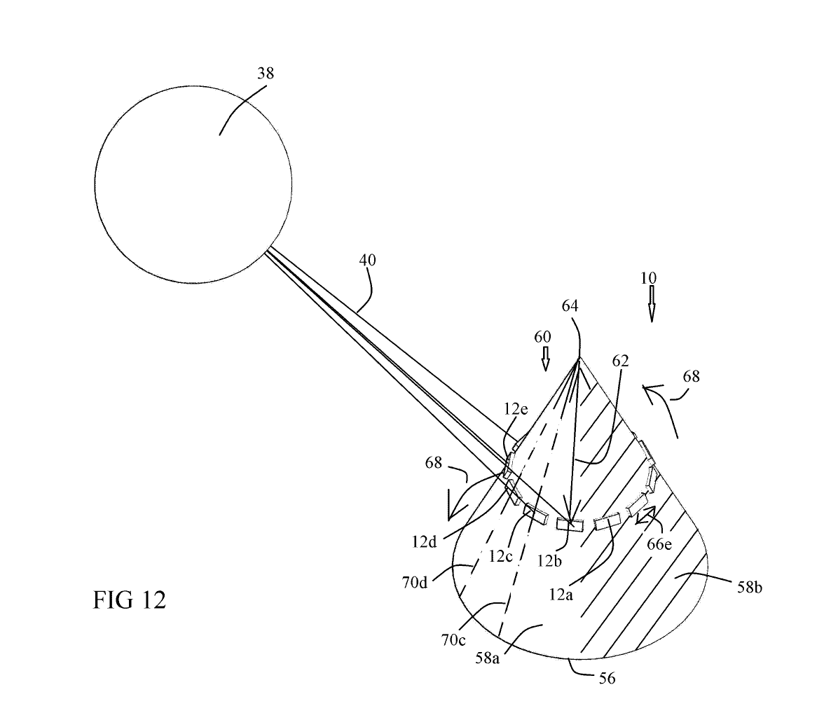

FIG. 12 depicts a sunlight tracking sensor according to another embodiment.

A sunlight tracking sensor 10 according to another embodiment, which may as well be installed on umbrella canopy 48, includes a right circular cone 60; and a plurality of light sensors 12a, 12b, etc., distributed all around, and all at a certain equal distance 62 from the apex 64.

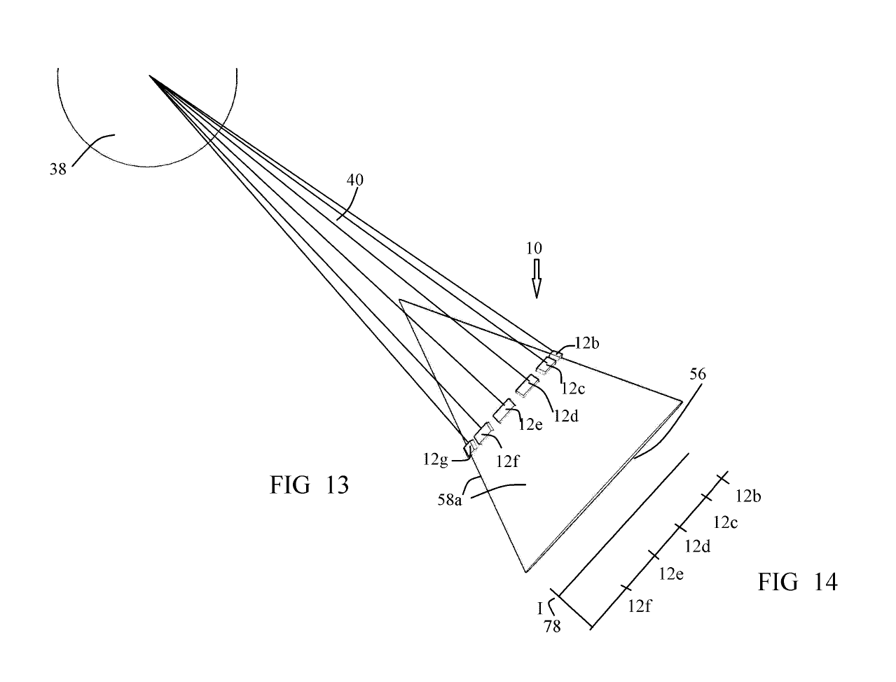

FIG. 13 depicts the position to which the sunlight tracking sensor of FIG. 12 must reach in relation to the sun, and the light measurement at this position.

FIG. 14 depicts light (I stands for Illumination) measurements of the various light sensors at the position of FIG. 13.

Sunlight tracking sensor 10 is designed to reach the position of FIG. 13, in which the sun 38 is above apex 64. This is obtained by comparison of the measurement of all of the sensors, upon receiving equal illumination from beams 40.

At any other position rather than that of FIG. 13, beams 40 reach only one half 58a of cone 60, while they don't reach the other half 58b, as depicted in FIG. 12.

FIG. 15 depicts the change of the position of the sunlight tracking sensor of FIG. 13 during the day.

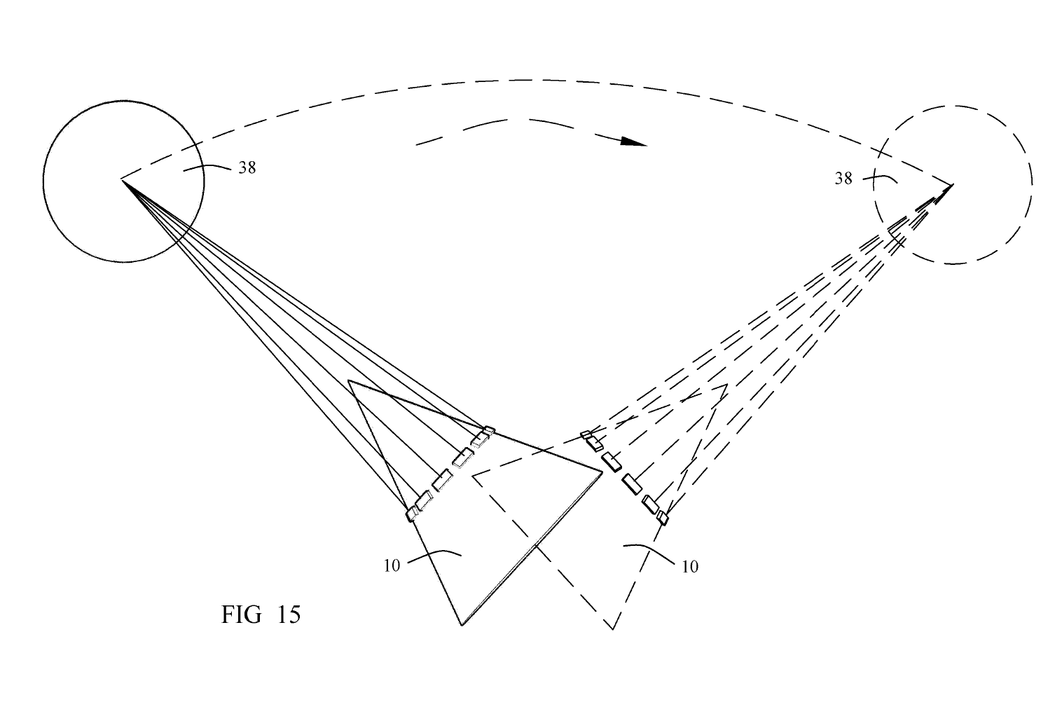

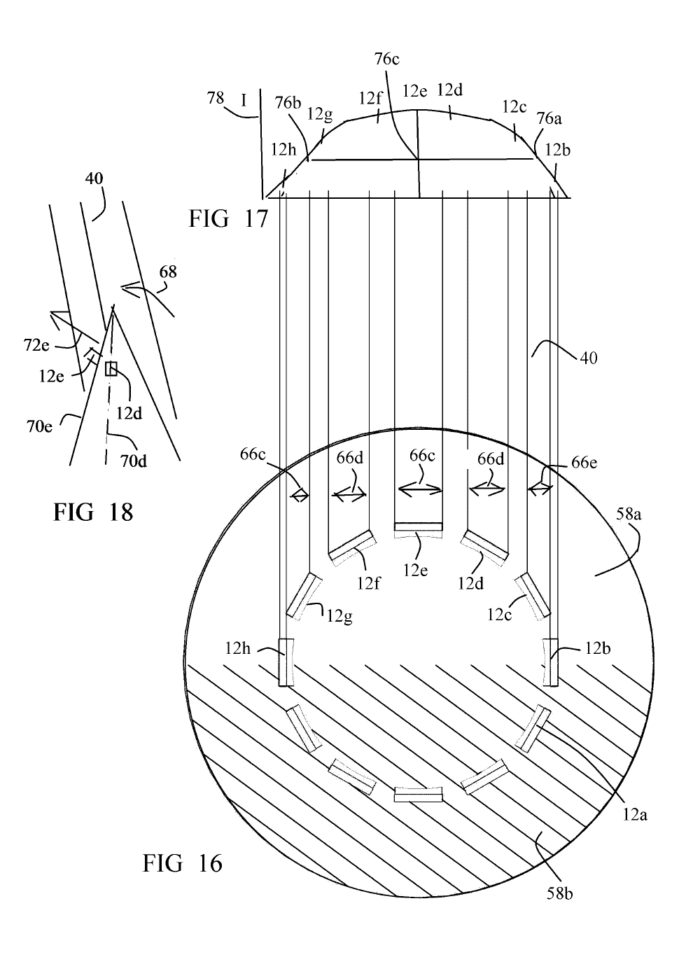

FIG. 16 is a two-dimensional sketch, for analyzing the beams at the position of FIG. 12.

FIG. 17 depicts light measurements of the various light sensors at the position of FIG. 16.

A configuration in which the length of all of the sensors is equal and being 66e, shown in FIG. 17, conveniently demonstrates the effect of sunlight tracking sensor 10.

The effective sensing length of sensor 12e, which currently faces the sun 38, is as well 66e. However, the effective sensing length of sensor 12d, being adjacent to sensor 12e, is 66d, which is smaller than 66e. And the effective sensing length of sensor 12c, being adjacent to sensor 12c, is 66c, which is smaller than 66d.

Thus, sensor 12e measures the highest illumination; sensor 12d measures less illumination than sensor 12e; sensor 12c measures less illumination than sensor 12d; and sensor 12b measures less illumination than sensor 12c.

The sensors need not require accurate measurements for determining the highest measuring one, since even if the difference between the measurements of sensors 12d, 12e and 12f is not resolved (this might be the typical state once the sun moves from the position of FIG. 13), the drops of the illumination measured by the side sensors, such as 12a is significant, and further the illumination interpolation graph 74 is accurately symmetrical, thus the center between the drops determines that the highest sensing sensor is 12e.

According to another embodiment, sunlight tracking sensor 10 may include even a great number of light sensors, and each may be tiny.

FIG. 18 depicts the direction to which the cone must move upon measuring the illuminations of FIG. 17.

In case sensor 12e measures the highest illumination, the motorized mechanism is responsible to tilt cone 60 along the linear vector 72e, being perpendicular to the line 70e, on which sensor 12e is disposed. Linear vector 72e provides torque 68.

In case sensor 12d measures the highest illumination, then the motorized mechanism is responsible to rotate cone 60 along the linear vector being perpendicular to the line 70d, on which sensor 12d is disposed.

Thus, in one aspect, the invention is directed to a sunlight tracking sensor (10), including:
a right circular cone (60) including a plurality of light sensors (12a, 12b) disposed thereon all around at a certain equal distance (62) from an apex (64) of the cone (60); and
a motorized mechanism, for tilting the cone (60) perpendicularly from the sensor which provides the highest light measurement (78),

thereby tilting the apex (64) towards a sun (38), being a position of which all of the plurality of light sensors (12a, 12b) provide equal light measurements (78).

The highest light measurement (78) may constitute a light measurement of a center (76c) between ends (76a, 76b) of an extrapolation (74) of a symmetrical graph of light measurements (78) provided by the plurality of light sensors (12a, 12b).

The sunlight tracking sensor (10) may be installed on a central top of an umbrella canopy (48), thereby shading under the central top.

In the figures and/or description herein, the following reference numerals (Reference Signs List) have been mentioned:
numeral 10 denotes a sunlight tracking sensor, according to one embodiment of the invention;
each of numerals 12i (i=a, . . . ,d) denotes a light sensor, such as a solar cell (also called a photovoltaic cell), that measures light intensity in a spot;
numeral 14 denotes a septum (wall);
numeral 16 denotes a cogwheel (connected to motor 18) which is a part of a transmission;
numeral 18 denotes a motor, for rotating base 56 of sensor 10 around vertical axis 54;
numeral 20 denotes a cogwheel which is a part of a transmission;
numeral 22 denotes a lens, as an example of an optical system mounted on cylindrical profile 26;
numeral 24 denotes a pole which embodies vertical axis 54;
numeral 26 denotes a cylindrical profile (wall);
numeral 28 denotes a motor, for rotating base 56 of sensor 10 around a horizontal axis 52;
numeral 30 denotes a cogwheel (connected to motor 28) which is a part of a transmission;
numeral 34 denotes a cogwheel which rotates base 56 around horizontal axis 52;
numeral 36 denotes an “area” sensor;
numeral 38 denotes the sun;
numeral 40 denotes a controller;
numeral 42 denotes a mechanism for rotating sensor 10 around a horizontal axis 52;
numeral 42′ denotes a mechanism that performs the operation of mechanism 42, on a remote device;
numeral 44 denotes a mechanism for rotating sensor 10 around a vertical axis 54;
numeral 44′ denotes a mechanism that performs the operation of mechanism 44, on a remote device;
numeral 46 denotes a communication channel, whether wired or wireless;
numeral 48 denotes a canopy of an umbrella, as an example of an object (such as a solar panel, an umbrella, and so on) to be turned towards the sun;
numeral 50 denotes a sunlight tracking system for turning object 48 towards the sun, that comprises a motorized mechanism that employs mechanisms 42′ and 44′, such as mechanisms 42 and 44 of the motorized system of sensor 10;
numeral 52 denotes an horizontal axis;
numeral 54 denotes a vertical axis; and
numeral 56 denotes a base (chassis) of sensor 10.

The foregoing description and illustrations of the embodiments of the invention has been presented for the purposes of illustration. It is not intended to be exhaustive or to limit the invention to the above description in any form.

Any term that has been defined above and used in the claims, should to be interpreted according to this definition.

The reference numbers in the claims are not a part of the claims, but rather used for facilitating the reading thereof. These reference numbers should not be interpreted as limiting the claims in any form.

What is claimed is:

1. A sunlight tracking sensor, comprising:
a right circular cone comprising a plurality of light sensors disposed thereon all around at a certain equal distance from an apex of said cone; and
a motorized mechanism, for tilting said cone perpendicularly from a sensor of said plurality of light sensors which provides a highest light measurement in relation to the others,
thereby tilting said apex towards a sun, being a position of which all of said plurality of light sensors provide equal light measurements.

2. A sunlight tracking sensor (10) according to claim 1, wherein said highest light measurement (78) comprises a light measurement of a center (76c) between ends (76a, 76b) of an extrapolation (74) of a symmetrical graph of light measurements (78) provided by said plurality of light sensors (12a, 12b).

3. A sunlight tracking sensor (10) according to claim 1, wherein said sunlight tracking sensor (10) is installed on a central top of an umbrella canopy (48), thereby shading under said central top.
